(19) United States
(12) Patent Application Publication
(10) Pub. No.: US 2004/0174921 A1
(43) Pub. Date: Sep. 9, 2004

(54) Optically based method and apparatus for accurately and automatically measuring the melting temperature of a material of interest

(76) Inventor: Dean Merrill Ball, Gainesville, GA (US)

Correspondence Address: Dean M. Ball, 4282 Pillsbury Road, Gainesville, GA, 30507, US

(21) Appl. No.: 10/382,739

(22) Filed: Mar. 7, 2003

(51) Int. Cl. G01N 25/02

(52) U.S. Cl. 374/20

(57) ABSTRACT

The melting point of a test substance is determined by placing it in a glass capillary tube within a metal block equipped with an electrical heater and temperature monitoring device. The temperature of the metal block and sample are gradually increased, often to temperatures that would damage electronic components. The output of a light emitting diode located a short distance from the metal block and away from the high temperature is coupled into a hollow tubing having highly reflective internal walls that carries the radiation to the glass capillary tube containing the test substance. A second hollow tube, also having highly reflective internal walls, is connected to a light detector that collects reflected radiation from the capillary tube. At the melting point of a solid, the light reflecting properties of the test substance decrease causing the light signal collected by the second reflective tube to decrease. The melt point is recorded as a change in the output voltage from the detector. The melting point detector is equipped with a number of ports for capillary tubes, internally reflective tubes, light emitters and detectors so that many phase transition points of different samples can be determined in one heating cycle. The outputs from the detectors are input to a computer and the detector signals are correlated with the temperature of the block. Melt point measurement accuracy is enhanced and analysis speed is improved by making the rate of heating of the block inversely responsive to the phase transition of the sample. This is done by correlating the first derivative of the light intensity with respect to temperature to the amount of heat input to the block.

### CROSS REFERENCE TO RELATED APPLICATIONS

Not Applicable

### STATEMENT REGARDING FED SPONSORED R & D

Not Applicable

### REFERENCE TO SEQUENCE LISTING, A TABLE, OR A COMPUTER PROGRAM LISTING APPENDIX

Not Applicable

### BACKGROUND OF THE INVENTION

This invention relates generally to apparatus and methods for detecting thermal properties of materials and, in particular to the determination of the melting point of one or more solids by means of changes in the optically reflective properties of the solid.

Melting points are very important in determining the purity of a substance and for characterizing samples. Melting Points are determined routinely in synthesis laboratories, analytical laboratories, in production facilities and in pharmaceutical laboratories. Historically, melting point determination is made by an observer simultaneously watching a sample and a thermometer while both are being heated in an oil bath or metal block. This method is time consuming, tedious, very subjective and is prone to errors caused by the difference in judgment by different observers. Automation of this process is desirable to relieve operators from the tedium of this task and to also increase the accuracy of measurement. Frequently it is necessary to determine the melting point of several samples at one time. An automatic method of measuring the melting point of several samples is therefore very desirable.

### SUMMARY OF THE INVENTION

It is a first object of this invention to provide improved methods and apparatus for detecting a phase transition in a substance or material of interest.

It is a further object of this invention to provide optically based methods and apparatus for simultaneously determining a phase transition temperature of a plurality of samples.

It is a further object of this invention to provide improved methods and apparatus to increase the accuracy of melt point determination while simultaneously increasing the speed of analysis.

The foregoing and other problems are overcome and the objects of the invention are realized by methods and apparatus in accordance with embodiments of this invention.

In accordance with a further aspect of this invention a high thermal conductivity block is provided with a heating element, a temperature sensor and a plurality of sample ports for holding a plurality of samples; a source of optical radiation; optical paths for transferring the optical radiation to the sample ports and for gathering scattered radiation from the samples; a detector of the radiation received back from the samples; and a device for recording the temperature and the radiation from the sample.

In accordance with a further aspect of this invention there is provided a method for determining the temperature at which a substance within a heated block changes state. The method includes the steps of monitoring the change in optical properties of the substance through internally reflective tubes, one of which carries radiation to the sample and a second one of which carries light from the sample. The intensity of the light received from the sample is monitored by a photodetector whose output is recorded by a computer equipped with a suitable analog-to-digital converter for data acquisition. The internally reflective tubes permit the light source (or sources) and detectors to be located remotely from the heated block. The heated block is designed to heat to temperatures in excess of 300° C. These internally reflective tubes thus protect sensitive electronic components used to generate and detect light from thermal damage.

An important advantage of the use of internally reflective tubes in the construction of a melting point apparatus is that the robustness of the apparatus is improved and the cost of the apparatus is significantly reduced as compared to units constructed using fragile, high temperature glass-fiber optic cables.

Although the apparatus can be constructed so as to provide a large number of ports, samples, internally reflective tubes and detectors, the relative slowness of the change in optical properties of the samples during a phase change permits the outputs of many detectors to be fed to a computer-based analog-to-digital converter with multiple inputs for acquiring and storing the data for each detector.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a partial cross sectional view of an apparatus according to one embodiment of this invention, wherein a cylindrical heating block has a two sample chambers and a two sets of internally reflective tubes are positioned so as to monitor the phase transition of samples in a reflective mode.

FIG. 2. is an isometric view of the of one embodiment of the invention wherein the analysis mechanism has three sample ports.

FIG. 3. is representative graph showing a change in photodetector output voltage versus temperature for a sample within one of the sample chambers of the embodiment of FIG. 1 or FIG. 2.

FIG. 4 is a graph of actual sample temperature inside the capillary at various heating rates.

FIG. 5 is a diagram of the electronic and computer control components of the invention.

### DETAILED DESCRIPTION OF THE INVENTION

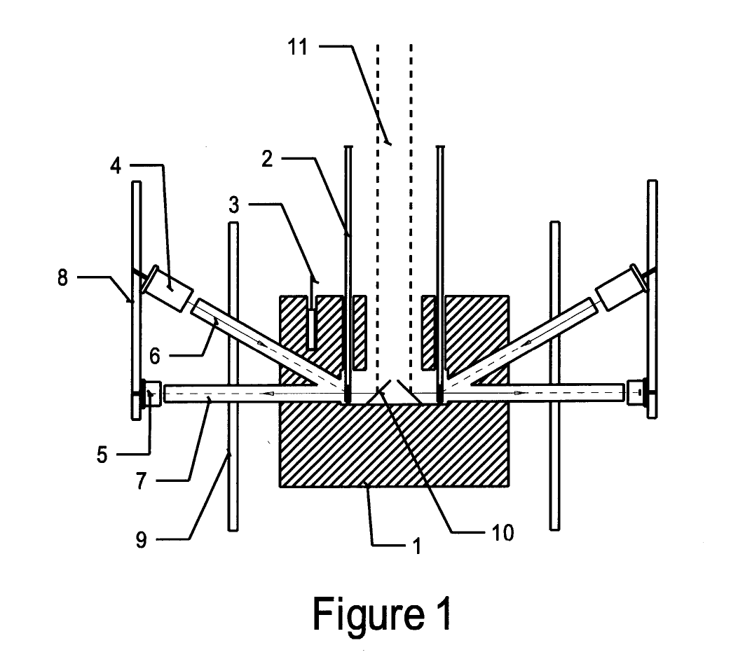

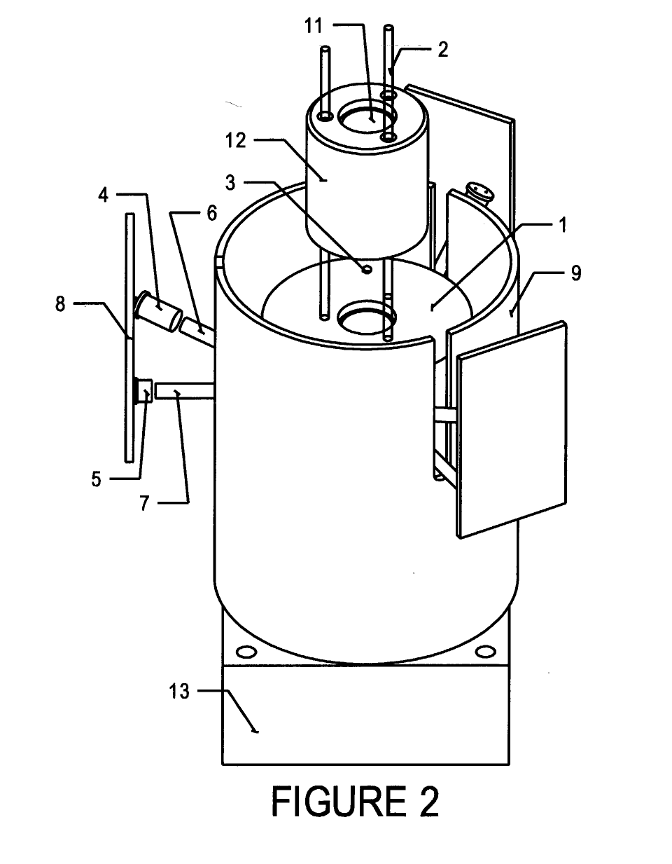

Referring to FIG. 1 and/or FIG. 2 a melt-point measurement (MPM) system includes a cylindrical heater block 1 comprised of metal or some other material that exhibits a high thermal conductivity. The block 1 is thus uniformly heated by an electrical heating element (not shown), which is uniformly wrapped around the outside of the metal block. This configuration distributes the heat evenly and prevents the creation of temperature gradients that would otherwise cause one sample tube to heat at a different temperature than another thereby causing inaccurate melt-point measurement. An exemplary, but not limiting, size of the block 1 is approximately 4.32 cm (diameter) by 3.8 cm (length). Although block 1 shows only two sample positions in FIG. 1 and three sample positions in FIG. 2, it is apparent that more such sample positions could be provided in a circular pattern around the cylindrical sample block 1. Glass sample capillary tubes 2 are conventionally 1.5-2 mm in diameter and have a length of 90-100 mm. The holes that contain the capillary tubes 2 are preferably only slightly larger in diameter than the capillary tubes 2. Due to the close proximity of the sample substances to the heated block 1, the samples are thermally coupled to the block 1 and are heated therewith. At least one temperature sensor 3, such as a well-known thermocouple or a resistance thermometer, is provided for measuring the temperature of the block 1.

An example of the heating element is a 122 cm length of #28 nichrome resistance wire. This wire is insulated with a fiberglass sheath and wrapped about nine times around the periphery of the block 1. The power to this heating element is provided by a regulated 24 volt DC power supply to provide about 35 watts of heating power. This configuration of the heater provides equal heat input to the circumference of the heater block and thus ensures that each sample position is at the same temperature.

As the temperature of the heater block 1 is increased, the temperature of the test substances in the capillary tubes 2 also increases accordingly and at some temperature, characteristic of the substance, a phase change takes place. The occurrence of the phase change of the substance in the capillary tube 2 is determined by a change in its optical properties.

As can be better seen in FIG. 1, the optical properties of the substance are monitored by a light emitter (LED) 4 and a light detector (photodiode) 5 mounted on a printed circuit board 8 and located on one end of the two internally reflective tubes 6 and 7. The light emitting device 4 transmits optical radiation (visible, ultraviolet, or infrared radiation) to the sample capillary tube 2 through an internally reflective tube (transmitter) 6. The light that is scattered or reflected from the test substance is efficiently collected and conveyed back to an optical detector (photodiode) 5.

It is important for the obtaining the highest accuracy of melting point measurement that the difference between the reflective properties of the solid sample and the reflective properties of the melted sample be as large as possible. This ratio can be called the signal-to-background ratio. Thus, the light detected when the sample is solid should be almost exclusively from the surfaces of the solid sample and, when the sample is melted, the light detected from the liquid sample and from all other sources should be as small as possible. In accordance with this requirement, one of the two internally reflective tubes 6 and 7 is arranged at an angle with respect to the other and with respect to the capillary tube axis so that light is not reflected back from the inside or outside walls of the capillary tube 2. If both of the two internally reflective tubes 6 and 7 were positioned at 90 degrees relative to the capillary tube 2 axis, the light from the tube walls (the background light) would be significantly higher. In experiments to determine this effect the background light intensity was about 700% higher when the internally reflective tubes 6 and 7 were both positioned at 90 degrees relative to the capillary tube 2 axis. Thus, the signal-to-background ratio is enhanced by having at least one of the two internally reflective tubes 6 and 7 at an angle with respect to the axis of the sample capillary 2.

Tubes 6 and 7 may be constructed from 3.2 mm×2.16 mm ID stainless steel tubing about 34 mm long. The inside of tubes 6 and 7 may be coated with a very smooth layer of silica (quartz) to increase the reflective properties and thus the efficiency of light reflection or they may be internally polished using conventional metal polishing techniques. Other methods of increasing the internal reflectivity of the tubes, such as electroplating or electropolishing may also be used.

High temperature glass fiber optic bundles would also suffice for the purpose of conducting the light into and out of the heated metal block 1 but high temperature glass fiber optics are much more expensive (about 30 times more expensive) and are much more fragile than a simple open tube with highly reflective internal walls. The internally reflective tube 6 and 7 is superior in this application because it makes the MPM system more reliable, easier to service, and less expensive to build relative to fiber optic cable.

A series of lenses could also be designed to provide optical coupling-at-a-distance from the sample to the light emitter and light detector. A lens configuration, however, would be much more expensive to build and align and would be more difficult to construct a large number of sample positions into the periphery of the sample block 1. The internally reflective tube 6 and 7 is, therefore, also superior to a lens-based design.

A polished cylindrical metal heat shield 9 surrounds the heater block 1 and reflects infrared radiation back to the block 1 as the temperature is increased. This action minimizes the heating of the sensitive electronic components 4, 5 and 8 while, at the same time, partially insulates the heating block 1 thus facilitating uniform heating.

In order for the operator to verify the proper operation of the MPM System, the phase changes of several samples can be visually monitored by observing the capillary sample tube reflected by first surface mirror 10 through observation port 11. This option is a requirement of some pharmaceutical companies on any automatic melt point measurement system.

An expressed object of this invention is to provide a system where a number of samples can be large. This is accomplished by providing a desired number of capillary sample ports and the associated photoemitters, photodetectors, and internally reflective tubes.

An expressed object of this invention is to provide a system with improved meltpoint measurement accuracy. The following table defines one source of melt point measurement inaccuracy.

| | Melting Point determined, in ° C. |
|---|---|
| Rate of heat rise ° C./min | (According to the pharmacopoeia) |
| 0.2 | 82.5 |
| 0.5 | 82.8 |
| 1.0 | 83.3 |
| 2.0 | 83.6 |

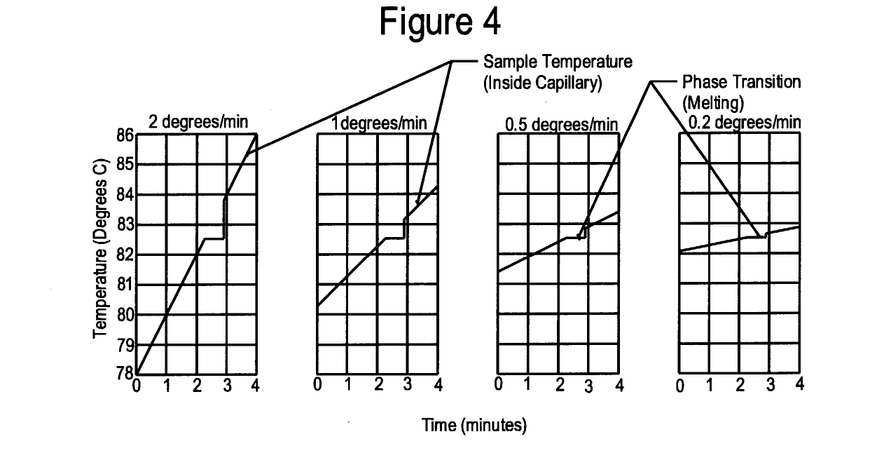

The apparent melting point is affected by the rate of heat rise because the sample absorbs more heat when undergoing a phase transition. This additional heat is called the heat of fusion and is common to all crystalline substances. This effect is illustrated in FIG. 4. As the phase transition occurs and heat is absorbed by the sample, the actual sample temperature inside the glass capillary lags behind the heated metal block and temperature sensor. At higher heating rates the lag is greater than at low heating rates thus causing a greater measurement errors at higher heating rates.

Thus, the highest accuracy is obtained when the rate of heat rise is less than 0.2° C./min. The problem with this is that temperature scans of as much as 200° C. are common in determining the melting point of an unknown substance. This would require up to 1000 minutes or 16.67 hours for one analysis. In a laboratory environment, where time is very valuable, this amount of time for one analysis is unacceptable.

A solution to this problem, which is one of the objects of this invention, is to heat the sample at a fast rate, for example 2.0° C./min as long as the sample is not changing phase but when the sample begins to melt, the rate of heating is slowed to 0.2 or even 0.1° C./min for the small temperature span that the sample is melting. After the sample is completely melted the rate of heat rise is automatically resumed at the higher rate. This ensures that the highest accuracy is obtained for melt point measurement, while at the same time, decreases the overall time required for analysis.

The method of achieving this objective is to first measure the reflected light intensity from the sample; second to calculate a first derivative of the light intensity with respect to temperature and third to make the heating rate inversely responsive to an increase in the first derivative. As long as the reflected light intensity does not change, the first derivative will be near zero and the heating rate can be near the maximum limit but when the sample begins to melt, the first derivative will increase and the heating rate can be made to decrease proportionally using well-known computer algorithms or analog circuitry.

Thus, with controlling the heating rate using the inverse of the first derivative of reflected light intensity with respect to temperature, the optimum heating rate is used when the sample is melting, while when the sample is not melting, the maximum heating rate is used. This method combines maximum analytical accuracy and maximum analysis speed thus making the apparatus more useful for the purpose it was intended.

Table 1 is illustrative of the type of data obtained by the use of the apparatus and method described herein.

TABLE 1
Melt Point Reproducibility
Degrees Celsius

| Test Number | Benzophenone | Vanillin | Cholesterol |
|---|---|---|---|
| 1 | 48.58 | 81.75 | 145.7 |
| 2 | 48.58 | 81.75 | 145.75 |
| 3 | 48.47 | 81.75 | 145.75 |
| 4 | 48.6 | 81.76 | 145.7 |
| 5 | 48.6 | 81.76 | 145.7 |
| 6 | 48.55 | 81.82 | 145.7 |
| 7 | 48.49 | 81.82 | 145.75 |
| 8 | 48.49 | 81.76 | 145.7 |
| 9 | 48.49 | 81.76 | 145.7 |
| 10 | 48.51 | 81.74 | 145.64 |
| 11 | 48.56 | 81.74 | 145.64 |
| 12 | 48.51 | 81.79 | 145.64 |
| Average: | 48.54 | 81.77 | 145.71 |
| Standard Deviation: | 0.05 | 0.03 | 0.03 |

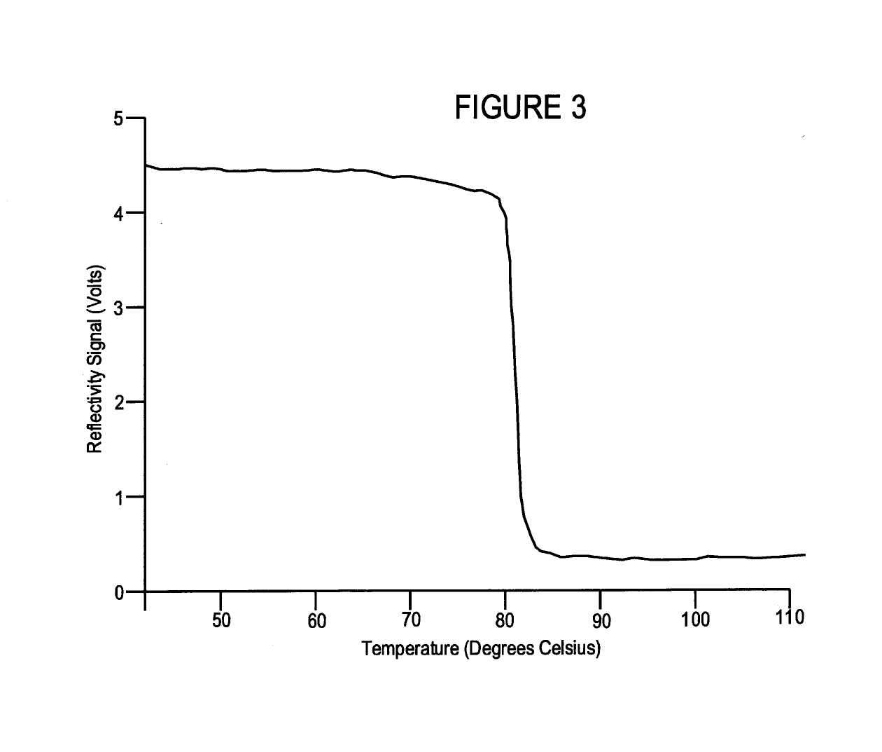

As can be seen in the vanillin example of FIG. 3, a record of the temperature of the detector block 1 versus sample reflectivity clearly indicates the temperature where the phase transition takes place.

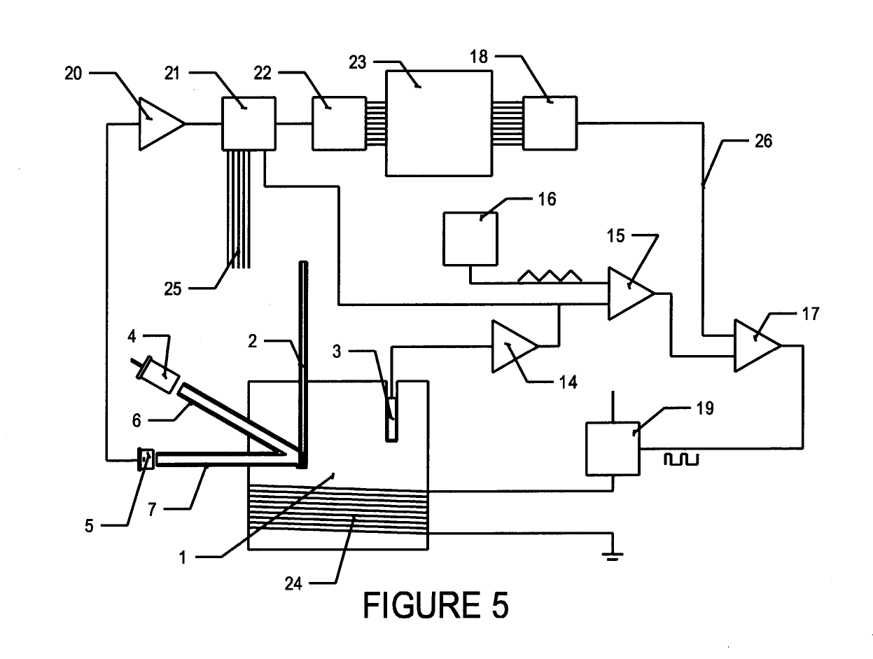

Referring to FIG. 5, temperature control of the heater block 1 is obtained by sensing the temperature of the block using the temperature sensor 3 and temperature-to-voltage converter 14. This temperature-responsive voltage is then summed with a saw-tooth voltage waveform generated by sawtooth generator 16 by the summing amplifier 15. The sawtooth waveform has an amplitude, also known as bandwidth, corresponding to about 0.5 to 1 degree Celsius. The summed voltage waveform is then compared to the command voltage 26 from the digital-to-analog converter 18 using a comparator 17. When the control voltage 26 is higher than the voltage corresponding to the temperature, the comparator will be high, the solid state relay 19 will be turned on and power will be applied to the heater block 1. This will cause resistive heating of the nichrome heater 24 and the temperature of the heater block 1 will increase. As the temperature increases, the voltage corresponding to the temperature will increase, and as this voltage approaches the value of the control voltage 26, the comparator will begin to turn off for short periods of time thus decreasing the amount of power to the heater and moderating the heating. If the temperature increases to the point that the temperature is higher than the set point plus the bandwidth, the power will be completely turned off and the heated block 1 will begin to cool. In this manner a stable and precise control of the heater block 1 is realized.

During a sample analysis a capillary tube loaded with the sample is inserted into the heater block 1. The initial and final temperatures are then selected and the analysis is started. The Control Computer 23 gradually increases the output of the Digital-to-Analog Converter thus increasing the temperature of the heated block. The Control Computer continually monitors and records this temperature through the Multiplexer 21 and Analog-to-Digital converter 22. At the same time, the Control Computer 23 also monitors the optical reflectivity of one or more samples through Silicon Photodiode 5, Photocurrent-to-voltage converter 20, multiplexer 21 and analog-to-digital converter 22. Signals from additional channels 25 are applied to the multiplexer 21 As the temperature increases, the temperature is continually recorded and the optical reflectivity of all the sample positions is recorded. When the upper set temperature is reached, the data is analyzed and the melting point of the sample(s) is determined.

Having thus described the construction and operation of presently preferred embodiments of this invention, it will be understood by those having skill in the art that a number of modifications can be made to these presently preferred embodiments. By example only, other wavelengths, component types, numbers of capillary chambers, heater block geometries, and so forth can be employed, and such modifications will still fall within the scope of the teaching of this invention.

Thus, while the invention has been particularly shown and described with respect to preferred embodiments thereof, it will be understood by those skilled in the art that changes in form and details may be made therein without departing from the scope and spirit of the invention.

What I claim as my invention is:

1. A method for determining a temperature at which a substance melts, comprising the steps of: providing the substance in a transparent container;
and while changing the temperature of the substance, directing an optical beam through a first internally reflective tube onto the substance;
collecting with a second internally reflective tube a portion of the optical beam that reflects from the surfaces of the substance;
conveying the collected portion of the optical beam through the second internally reflective tube to a photodetector;
monitoring at an output of the photodetector a change in the reflective property of the substance;
and responsive to a detected change in the reflective property of the substance, correlating a temperature of the substance with a phase transition point of the substance.

2. A method as set forth in claim 1, wherein the optical beam is produced by one of a continuously or intermittently operated light emitting diode, solid state diode laser, and incandescent bulb that is coupled to an end of the first internally reflective tube.

3. A method as set forth in claim 1, wherein the step of analyzing includes a step of calculating a derivative of the photodetector output signal with respect to temperature, and a step of using the derivative to control the rate of heating of the sample.

4. A method as set forth in claim 1, wherein the first internally reflective tube and the second internally reflective tube are at an angle of from 5 to 60 degrees with respect to each other and are arranged axially with respect to the sample tube.

5. A method as set forth in claim 1 for simultaneously determining the melting point of several samples by providing several analysis positions in a common heated block.

6. Apparatus for simultaneously determining a phase transition point for a plurality of samples, comprising: means for providing a plurality of samples that are thermally coupled to a common substrate;
means for varying a temperature of the substrate for simultaneously varying the temperature of each of the plurality of samples; a plurality of internally reflective tubes for directing individual ones of a plurality of optical beams onto individual ones of the plurality of samples;
a plurality of second internally reflective tubes for collecting a portion of the individual one of the optical beams that reflects from one of the samples;
a plurality of photodetectors individual ones of which are optically coupled to an individual one of the second internally reflective tubes for receiving the collected portion of the optical beam therefrom;
means, coupled to an output of each of the plurality of photodetectors, for detecting a change in the reflective property of the associated one of the plurality of samples, and, responsive to a detected change reflective property of one of the samples, for correlating a temperature of the sample with a phase transition point of the sample.

7. Apparatus as set forth in claim 6, wherein the plurality of optical beams are produced by one of a continuously or intermittently operated light emitting diode, solid state diode laser, or incandescent bulb that is coupled to an end of individual ones of the plurality of internally reflective tubes.

8. Apparatus as set forth in claim 6, wherein the step of analyzing includes a step of calculating a plurality of derivatives of the individual ones of photodetector output signals from a plurality of samples with respect to temperature, and a step of using the derivative of one of those sample signals to control the rate of heating of the samples.

9. Apparatus as set forth in claim 6, wherein the plurality of first internally reflective tubes and the second internally reflective tubes are at an angle of from 5 to 60 degrees with respect to each other and are arranged axially with respect to individual ones of a plurality of sample tubes.
